(19) United States
(12) Patent Application Publication
(10) Pub. No.: US 2009/0024535 A1
(43) Pub. Date: Jan. 22, 2009

(54) Finite Equity Financial Instruments

(76) Inventor: Peter Kleidman, Stamford, CT (US)

Correspondence Address: VENABLE LLP, P.O. BOX 34385, WASHINGTON, DC, 20043-9998, US

(21) Appl. No.: 11/573,968

(22) PCT Filed: Aug. 22, 2005
(86) PCT No.: PCT/US2005/029856

§ 371 Date: Oct. 27, 2007

Related U.S. Application Data
(60) Provisional application No. 60/603,396, filed on Aug. 20, 2004.

(51) Int. Cl. G06Q 40/00

(52) U.S. Cl. 705/36 R

(57) ABSTRACT

The value of finite equity-based financial instruments is related to future financial performance of an underlying company or companies. One instrument based on periodically reported financial performance operates on a swap basis between two parties. One party pays the second party a fixed, negotiated in advance, payment at the end of one or more calculation periods during the lifetime of the instrument. The other party pays the first party a variable payment equal to the reported financial performance during the calculation period multiplied by a percentage predetermined in advance. A second finite equity instrument is freely traded on a futures exchange between an issue date and a settlement date. At the settlement date the price of the instrument is fixed at a settlement value which is derived from the summed financial results of a company or companies between the issue date and the settlement date.

The present application claims priority from U.S. Provisional Patent 60/603396 filed Aug. 20, 2004 which application is incorporated herein by reference to the extent permitted by law.

### BACKGROUND OF THE INVENTION

1. Area of the Art

The present invention deals with the financial arts and more specifically a new financial instrument

2. Description of the Prior Art

### Finite Equity Financial Instruments

Financial instruments such as stocks or bonds are a vital and essential part of a free market economy. They provide a convenient means for companies to obtain much needed capital while also providing a means for individuals or institutions to invest in and directly product from the performance of the economy. It is generally believed that a well diversified investment portfolio is able to overcome transient economic variations essentially by spreading the investment risks. As a result an every increasing variety of derivative financial instruments has become available to permit increased investment diversity. The value of such instruments at a given time is related to (derives from) the economic performance of an asset. Through such instruments it is possible for a sophisticated investor forecast economic performances and profit from correct forecasts. This allows the investor to control investment risk and buffer an investment portfolio against large negative swings.

A Finite Equity financial instrument is the generic term for any one of a suite of derivative products whose value is linked directly to the financial results (e.g., net earnings) of a company or asset for a specified period of time, such as two, five, ten or even 30 years. This feature is in direct contradistinction to a stock (or other traditional equity-related product) that represents the market's perception of the overall value of a company in perpetuity, with no reference to its performance over a specific time period. Most notably, the value of a stock is often thought of as the net present value of all future earnings of a company, taken in perpetuity. The distinction and advantage of a Finite Equity product is that it allows the participant to take a view on the performance of the company for a specified period of time only, stripping out the market's perception or projections of the company's performance outside said time period. That is, a savvy investor can make a studied prediction of a company's performance over a period of time and profit from the correct predictions. Investing in such products covering a diversity of companies is an excellent way buffering an investment portfolio against economic swings.

A Finite Equity financial product is a derivative product whose value can be linked directly to the net income and dividends of a specified company for a specified period of time only. The net income and dividends of the company outside the specified period of time have no bearing on the performance or value of the Finite Equity product (except in certain aberrational circumstances where the reference company ceases to exist or unexpectedly fails to report its performance within the specified time period).

### SUMMARY OF THE INVENTION

The value of finite equity financial instruments is related to future performance of a company. The value of one instrument is based on periodically reported financial performance of a company, and the instrument operates on a swap basis between two parties. The first step is to establish a fixed money obligation to be periodically paid by the first of the two parties. The next step if to establish a fixed percentage used to calculate a variable money obligation to be periodically paid by the second of the two parties. The variable obligation represents the fixed percentage multiplied by financial results periodically reported for the underlying company or companies. These factors are set by the parties according to their individual assessments on how the underlying company or companies are likely to perform. A start date and a maturity date are set for the instrument, and the time period between these dates is divided into a plurality of calculation periods. At the end of each calculation period the first party pays the fixed obligation to the second party. In turn the second party pays the variable obligation, determined according to the variable percentage and the financial results reported for the company during the calculation period, to the first party.

A second finite equity-based instrument is freely traded on a futures exchange between an issue date and a settlement date. At the settlement date the price of the instrument is fixed at a settlement value which is derived from the summed financial results of a given company between the issue date and the settlement date. To create and trade such an instrument the exchange establishes an issue date and a settlement date for the instrument. The exchange also sets a scaling factor selected so that a settlement value, wherein the settlement value is equal to a sum of financial results reported by the security or securities from and including the issue date but excluding the settlement date multiplied by the scaling factor; is likely to fall within a predetermined convenient range of currency units. Then the exchange issues the instrument whereupon traders can purchase and sell the instrument through the exchange until the settlement date is reached. When the settlement date is reached, the exchange establishes the settlement value, and the traders pay the settlement value to redeem outstanding instruments. During trading before the settlement date the price of the instrument will reflect performance of the security up to that date and an assessment by the traders as to the likely future performance of the company.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide new finite equity-based financial instruments.

The new Finite Equity instruments disclosed herein are the Earnings Swap and the Earnings Future. These instruments are based on the financial (economic) performance or results of a designated company or group of selected companies. Financial or economic results basically describes the earnings or losses of the company or companies. Financial results can be expressed in terms of income, net income or in terms of any other customary accounting calculation. The financial data necessary for operation of these instruments normally comes from public disclosures of the company or companies. The basis on the company or companies may be indirect in that the instruments can also be referenced to the proportion of earning or loss of the company/companies allocated to a particular security (e.g., stock shares or a particular class of shares).

### Earnings Swap

In an Earnings Swap Counterparties A and B (each a “Counterparty”) enter into a swap agreement which, for example, can be governed under the guidelines of the International Swap Dealers Association (ISDA). The Earnings Swap references earnings of an underlying company; this can also be expressed in terms of the earning allocated to a particular security-for instance a specific class of shares of a specific public company (“Company”). At predetermined times the Counterparties exchange payments. One Counterparty pays a fixed amount and the other pays a specified percentage (“Earnings Multiplier”) of the after-tax net income and dividends (or the fraction thereof allocable to the reference shares), as reported by the Company in its quarterly financial statements.

Following is an example of the terms and conditions of an Earnings Swap according to the present invention:

| | |
|---|---|
| Underlying Company: | Public Company XYZ |
| Start Date: | Nov. 28, 2004 |
| Maturity Date: | Nov. 28, 2009 |
| Calculation Periods: | Quarterly, commencing Feb. 28, 2005 and |
| | quarterly thereafter until Nov. 28, 2009 |
| | (subject to Modified Following Business Day |
| | Convention) |
| Payment Dates: | Two business days after the end of the |
| | Calculation Period |
| Earnings Multiplier: | 0.30% |
| Counterparty A | $250,000 |
| Payments: | |
| Counterparty B | All Net Income and Dividends of the |
| Payments: | Underlying Company in the preceding |
| | Calculation Period, multiplied by the |
| | Earnings Multiplier |
| Net Income: | The net income as reported by the Company in |
| | accordance with United States securities laws. |
| Dividends: | The aggregate dividends (expressed as a |
| | dollar amount, rather than a per-share figure) |
| | paid to all holders of the Underlying Company. |

Example of payments: If in the Calculation Period from (and including) May 28, 2006 to (but excluding) Aug. 28, 2006, the net income is $80,000,000 and no dividends are distributed, then the Counterparty B payment shall be 0.0030×$80,000,000=$240,000. By exchanging payments the payments are effectively netted, the resulting cash flow under the swap is a net payment of $10,000 ($250,000 less $240,000) from Counterparty A to Counterparty B two business days after Aug. 28, 2006.

It will be appreciated that if the parties set the multiplier and fixed payment so that the payments of Counterparty B are expected to equal the fixed payment of Counterparty A, and the underlying company underperforms Counterparty A will pay Counterparty B. Similarly, if the underlying company overperforms, Counterparty B will pay Counterparty B. Thus, with this financial instrument Counterparty B can hedge against underperformance of the underlying company. The precise fixed payments and earnings multipliers selected will reflect the assessment of each party of how the underlying company is likely to perform over the life of the Earnings Swap.

Provisions must be adopted to cover the case in which aberrational circumstances affect the regular quarterly reporting of Net Income in accordance with its regularly scheduled quarterly periods, pursuant to United States securities laws:

1. Restatement of Net Income—If there is a restatement of Net Income, then future payments under the Earnings Swap must be adjusted at the Payment Date immediately following the restatement, to compensate for the incorrect payments, which have occurred in the past. By way of example, if in October 2007 it is announced by the Company that the Net Income reported in the Calculation Period ending Aug. 28, 2006 is restated upward to $100,000,000, then the Counterparty B payment of $240,000, which occurred two business days thereafter must be adjusted upwards by $60,000 from $240,000 to $300,000. As a consequence $60,000 must be added to the Counterparty B payment, which is due two business days after the Calculation Period ending Nov. 28, 2007. The Counterparties may agree at the outset that any such adjustment payments occurring as a result of a Net Income restatement be grossed up at LIBOR (London Inter-Bank Offer Rate) or to some similar index to compensate the receiving Counterparty for the time value of money.

At the outset of the transaction, the Counterparties must agree on provisions to handle the case in which Net Income that occurred during the Earnings Swap is restated after the Maturity Date. The Counterparties may agree that once the Maturity Date is reached, all payments are irrevocable so that no adjustments can be made to the payments under the Swap, even if restatements of Net Income that occurred during the Swap are later declared. Another reasonable approach is to allow for some a time of 6-12 months after the Maturity Date—any restatements occurring within this time will give rise to retroactive adjustments in the Earnings Swap.

2. Delay in reporting—If the Company delays its reporting of Net Income in a given quarter, then payments on the Earnings Swap are to be suspended until such time that the Company announces its Net Income. Payments should occur on the originally scheduled Payment Dates, but payments should be increased by adding on interest accrued at LIBOR to compensate the Counterparties for the time value of money. If earnings announcements are delayed past the Maturity Date, then the Swap should be extended to accommodate this delay in reporting. For example, if the Net Income which under ordinary reporting schedules would have been reported in the Calculation Periods ending in August 2008 and November 2009 do not occur, then the Counterparties should keep the Earnings Swap in effect until such time that the Net Income for those quarters is eventually reported.

3. Permanent cessation due to bankruptcy or other form of permanent winding down—If the Company permanently winds down and as a consequence announces that it will no longer issue any financial reports, then under these circumstances it is to be assumed for the purposes of the Earnings Swap that all future Counterparty B payments are zero. The Earnings Swap can continue with regular payments by Counterparty A and zero payments on the part of Counterparty B. As an alternative, the Counterparties can agree to terminate the Earnings Swap with a lump-sum payment from Counterparty A to Counterparty B, representing the fair value of all future cash flows.

4. Permanent cessation due to merger or acquisition—To cover the case in which Company ceases to report its Net Income due to merger with or acquisition by another company, the Counterparties must have provisions in place describing how the remaining cash flows in the Swap are to be treated. Here are several possible alternatives.

a) Early termination—The Earnings Swap simply terminates, with no further obligations on the part of either Counterparty to make any further payments. The advantage to this method is its simplicity. The disadvantage is that it does not reflect the potential earnings the Company would have had after the merger or acquisition took place.

b) Determination of Implied Future Net Income—In the case of a merger or acquisition (“Transaction”), the value transferred to owners of the underlying company (either in the form of cash, stock or other securities or assets) in consideration for their equity stake in the Company will be specifically determinable in a relatively straightforward manner. If the value is transferred in cash, then such value will be wholly explicit. If the value is transferred in stock, then the value of such stock can be observed at a specified time on the day of the closing of the Transaction. The value so determined will be referred to as the Purchase Price (even though Transaction might not be an outright purchase) Once the Purchase Price is established, Implied Future Net Income is to be determined for the purpose of establishing the payments of the remaining Calculation Periods in the Earnings Swap.

One reasonable method for determining Implied Future New Income is the Constant Growth Rate Mechanism. This mechanism assumes that Net Income of the underlying company will grow at a constant rate for the foreseeable future and then remain constant thereafter. The Purchase Price (P), the Initial Net Income (I), the Discount Factors (Dt), the Initial Annual Growth Rate (G) and the number of years (N) of Net Income growth, satisfy the following formula:

P=I*( Σ(1 +G)^{t}* Dₜ)+I*(Σ(1+G)^{N}* Dₜ),

where the first summation is take for t=1, 2, . . . , N and the second summation is taken for t=N+1, N+2, . . . (ad infinitum). The first summation represents N years of constant Net Income growth and the second summation represents the remaining years with zero growth and Net Income held constant at I*(1+G)^{N}.

### Alternatives and Variations

1). Frequency of Payments—The swap payments and Calculation Periods can occur semi-annually or annually, or for that matter at any time intervals, regular or irregular, as agreed upon by the Counterparties. Quarterly was used for illustration purposes only.

Semi-annual or annual payments may be necessary in foreign jurisdictions where earnings are reported less frequently.

2). Alteration of fixed payment leg—The payments of Counterparty A can be expressed in other terms, for example as a function of LIBOR or any other floating rate.

3). Forward-starting transactions—The swap can start immediately upon transacting or at some future some date. For example, counterparties which enter into the transaction in 2004 can agree that the Earnings Swap is in effect from 2008 to 2011.

### Earnings Future

An Earnings Future, which is an exchange-traded instrument, settles at maturity to a price based on financial performance of an underlying company (or companies) over the life of the instrument. For example, the maturity price could equal to the sum of, for example, all Net Income and Dividends earned by the company or allocable to all or some subset of the shares of the company taken from the inception of the earnings future to its maturity date. Thus, price of the instrument is based on the earnings future of a company. During the life of the instrument it is traded on a futures exchange at a negotiated price reflective of the ultimate expected price at maturity. For example, if traders determines that the maturity price will be high (that is the company is doing well and will continue to do well), the selling price of the instrument will be bid up. The price at which a given investor buys or sells depends on the investor's analysis of future earning as reflected by performance of the company to date. As the maturity date gets closer and closer, the final determination of the maturity price becomes more certain as there are fewer outstanding financial reports. It is anticipated that the instrument price will reflect the likely maturity value. At maturity of the future earnings instrument the holders of the instrument must pay the maturity price (the settlement value, see below) and the instrument ceases to exist just like an ordinary futures contract. In actual practice the purchase and sales prices and the settlement value would be handled through the trader's margin accounts.

Example of an Earnings Future:

| | |
|---|---|
| Underlying Company: | Public Company XYZ |
| Issue Date: | Determined by Exchange (example, quarterly |
| | on the first of March, June, September and |
| | December of each year) |
| Settlement Date: | 5 years from the Issue Date |
| Settlement Value: | The sum of all Net Income and Dividends |
| | allocated to the underlying company, as |
| | reported by the Company in its official financial |
| | statements issued in accordance with United |
| | States securities laws, from and including the |
| | Issue Date to but excluding the Settlement |
| | Date, all multiplied by the Scaling Factor. |
| Scaling Factor: | This is a multiplier determined by the |
| | Exchange before the Issue Date, chosen so |
| | that the Settlement Value in likely to fall within |
| | a convenient range; for example if the currency |
| | is dollars a value between minus 1,000 and |
| | plus 1,000 dollars would be appropriate. For |
| | other currency unite (i.e., Euros, rubles, yen, |
| | etc.) a different range might be appropriate. It |
| | is convenient for the scaling factor to be an |
| | exponent of ten, although other approaches |
| | can be adopted. For example, if the most |
| | recent quarterly Net Income of the Company is |
| | $80,000,000, then the Exchange would likely |
| | choose a Scaling Factor of 1,000,000 = 10⁶, so |
| | that the contribution of such an earnings |
| | outcome would be $80 to the Settlement |
| | Value. |

Restatement of Earnings If there is any restatement of earnings after the Settlement Date, Earnings, then there shall be no adjustment to the Settlement Value. If there is a restatement of earnings before, that shall effect the corresponding adjustment to the Settlement Value of the instrument.

Failure to Report: If for some reason the Company does not report its quarterly results, then trading in the future earnings instrument can continue, but the ultimate settlement price still needs to reflect a full five years (or other selected period) worth of Net Income and Dividends. Thus, the Exchange may have to postpone the Settlement Date if the Company delays its reporting. If the Company goes into bankruptcy, is wound down, merged or is acquired by another company, and therefore is in a position where it will no longer issue any Net Income and Dividend data, then special provisions need to be devised, similar to those discussed in the Earnings Swap, above. For example, in the case of bankruptcy, future Net Income and Dividends can be marked down to zero. In the case of a merger or acquisition, the implied future Net Income and Dividends can be determined using the Purchase Price and a constant growth model, as described above.

Variations: The maturity of the contract can be some length of time other than 5 years, such as 2 years, 10 years or 30 years.

### Related Products and Features

1. Rather than using Net Income, the participants in a Finite Equity product may choose to strip out any extra-ordinary income and tailor the product so that is linked only to net income from operations. Similarly taxes may be stripped out so that the Finite Equity product is linked only to pre-tax income.

2. Baskets—The aforementioned instruments can be easily be based on a plurality of companies, that is, a basket of various companies. Such a transaction would effectively be a sum of the individual aforementioned transactions combined into one.

3. Classes of Shares—The aforementioned instruments can be easily modified so that the Net Income and Dividends to be considered are limited to only a single class of shares of stock in the Underlying Company, or a specific subset of shares, rather than all of its shares. For example, the Earnings Swap or the Earnings Future can be linked only to the Net Income and Dividends allocable to Class A shares of Company XYZ.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. A method of providing a finite equity instrument referenced to financial results of an underlying company or companies and effectuated by swapping between two parties, the method comprising the steps of:
establishing a fixed money obligation to be periodically paid by the first of the two parties;
establishing a fixed percentage used to calculate a variable money obligation to be periodically paid by the second of the two parties which variable obligation represents the fixed percentage multiplied by financial results periodically reported for the underlying company or companies;
setting a start date and a maturity date;
dividing the period of time between the start date and the maturity date into a plurality of calculation periods;
determining the variable money obligation for each calculation period according to the financial results reported during the calculation period; and
exchanging payments determined according to the money obligations at the end of each calculation period whereby the fixed money obligation is effectively netted with the variable money obligation.

2. The method of claim 1 further comprising the step of adjusting future variable payments to correct for any restatement of the financial results.

3. The method of claim 1 further comprising the step of delaying the determination of the variable money obligation when the financial results are not reported during a specific calculation period.

4. The method of claim 1, wherein the step of exchanging payments is replaced by a step of making net payments where the party having the larger of the two obligations pays the net difference between the obligations to the party having the smaller of the two obligations.

5. The method of claim 1 further comprising the step of terminating the instrument in response to merger or acquisition of the underlying company or companies.

6. The method of claim 1 further comprising the step of determining implied future net income in response due to merger or acquisition, said implied future net income being used to establish the variable payment obligations for future calculation periods.

7. The method of claim 6, wherein a constant growth rate calculation is used to determine implied future net income.

8. The method of claim 1, wherein the intervals of the calculation periods are selected from the group consisting of quarterly, semi-annually and annually.

9. The method of claim 1, wherein the fixed money obligation is expressed in terms of a floating rate.

10. The method of claim 1, wherein the financial results are adjusted to exclude extra-ordinary income and to include only net income.

11. The method of claim 1, wherein the financial results are adjusted to exclude taxes and to include only pre-tax income.

12. A method of providing a futures exchange traded finite equity instrument referenced to financial results of an underlying company or companies, wherein the method comprises the steps of:
the exchange establishing an issue date and a settlement date for said instrument;
the exchange setting a scaling factor selected so that a settlement value, wherein the settlement value is equal to a sum of financial results reported by the underlying company or companies from and including the issue date but excluding the settlement date multiplied by the scaling factor; is likely to fall within a predetermined range of currency units;
the exchange issuing the instrument whereupon traders can purchase and sell the instrument through the exchange until the settlement date is reached;
the exchange establishing settlement value when the settlement date is reached; and
the outstanding instruments being terminated with the traders contributing or receiving funds according to the settlement value.

13. The method of claim 12, wherein the time period between the issue date and the settlement date is selected from the group consisting of two years, five years, ten years and thirty years.

14. The method of claim 12 further comprising the step of adjusting the settlement value to correct for any restatement of the financial results.

15. The method of claim 12 further comprising the step of delaying the settlement date when the financial results are delayed.

16. The method of claim 12 further comprising the step of terminating said instrument in response to merger or acquisition of the underlying company or companies.

17. The method of claim 12 further comprising the step of determining implied future net income in response due to merger or acquisition of the underlying company or companies, said implied future net income being used to establish the settlement value.

18. The method of claim 17, wherein a constant growth rate mechanism is used to determine implied future net income.

19. The method of claim 12, wherein the financial results are adjusted to exclude extra-ordinary income and to include only net income from the company or companies.

20. The method of claim 12, wherein the financial results are adjusted to exclude taxes and to include only pre-tax income from the company or companies.
